(19) United States
(12) Patent Application Publication
(10) Pub. No.: US 2002/0018873 A1
(43) Pub. Date: Feb. 14, 2002

(54) Method of using an alternative daily cover to contain compacted, baled waste and to dispose of the contained waste in a landfill

(76) Inventor: Randall Jeff Kozak, British Columbia (CA)

Correspondence Address: CONLEY ROSE & TAYON, P.C., P. O. BOX 3267, HOUSTON, TX, 77253-3267, US

(21) Appl. No.: 09/903,007

(22) Filed: Jul. 11, 2001

Related U.S. Application Data
(60) Provisional application No. 60/218,270, filed on Jul. 13, 2000.

(51) Int. Cl. B32B 3/04

(52) U.S. Cl. 428/129

(57) ABSTRACT

The present invention relates generally to a method for baling waste prior to the waste being disposed in a landfill by either encasing waste in degradable film and compacting the film and waste or wrapping compacted waste in degradable film. The preferred embodiment of the present invention includes a method for baling waste to maximize airspace savings while simultaneously fulfilling the environmental agencies' requirements for alternative daily cover. In the preferred embodiment of the method for baling waste of the present invention, the method comprises: compressing and compacting loose waste; inserting the compressed waste into a bag made from an alternative daily cover; and sealing the bag about the waste. The bag not only contains and encases the waste, but also maintains rigidity and form of the compressed bale.

The present application claims priority under 35 U.S.C. § 119(e) of the benefit of 35 U.S.C. § 111(b) provisional application Ser. No. 60/218,270 filed Jul. 13, 2000 and entitled “Waste Compacting And Encasing Process Using Degradable Film,” Application No. 60/218,270 hereby incorporated herein by reference.

The present invention relates generally to a method of using an alternative daily cover to contain compacted, baled waste (and recyclable waste), to dispose of compacted, baled waste in a landfill, and to store waste at a particular site. More particularly, the invention relates to a method for containing and sealing compacted, baled waste and for then disposing of the bagged and sealed waste in a landfill.

### BACKGROUND OF THE INVENTION

Pressure from regulators and waste facility management to conserve landfill space is greater now than ever before. Across the country, many cities, towns, and counties oppose the construction of new landfills in their community, making planning permission for new landfills increasingly difficult to obtain. Even when such permission is obtained, the cost for new landfill sites is becoming increasingly expensive. Facing these concerns, landfill operators must conserve as much existing landfill space as possible.

In addition to permission and cost concerns, federal and state governments have made landfill operation more cumbersome and time consuming by imposing numerous environmental regulations on waste disposal. For example, the United States Environmental Protection Agency (“USEPA”) and various state agencies mandate that, at the end of each day, after waste has been deposited in the landfill, landfill operators cover the open or working face of the landfill with six inches of soil, referred to as a “daily cover,” or with an acceptable alternative, referred to as an “alternative daily cover” or “ADC.” Daily cover and alternative daily cover are used to control, disease vectors, fires, scavenging, odor and blowing litter without presenting a threat to human health and the environment, as intended by USEPA regulations.

The open or working face of a landfill is the exposed surface of the trash, garbage, and other waste that is deposited at the landfill site during its operation. Although this waste may be enclosed in plastic bags, it also includes loose tree pieces, cans, small appliances, wood, shingles, building materials of all kinds, dirt, sludge, and other material permitted in a landfill. Using soil as a daily cover, it may take a landfill 45 minutes to cover a 15,000 square feet of open face at the end of each workday.

After years of research, EPI Environmental Products Inc. (“EPI”) developed a degradable and inexpensive film (“Enviro® Cover”) that has been approved by many state agencies for use as an ADC. The film and method for making the film are described in U.S. Pat. Nos. 5,416,133 and 5,565,503, each of which is hereby incorporated herein by reference. Because of its unique physical properties, Enviro® Cover provides multi-functional features at different times during the film's life. Newly laid film provides an ADC, provides a continuous barrier to rainwater infiltration, and effectively controls landfill gas emissions. As the film begins to degrade, the film barrier ceases to exist. This natural degradation method, for example by photo, thermo, mechanical stress, chemical, allows for the free movement of both leachate and methane within the landfill and enhances collection. The combination of these features greatly reduces the cost of leachate treatment, and eliminates leachate outbreaks.

EPI also developed, after years of research, a method and apparatus to deploy the Enviro® Cover, the method being described in U.S. Pat. No. 5,620,281 and the apparatus being described in U.S. Pat. No. 5,536,116, each of which is hereby incorporated herein by reference.

By maximizing available air space, extending the life expectancy of the landfill, and postponing the need for engineering and administration costs associated with site expansion, EPI's Enviro® Cover and the apparatus and method of deploying the Enviro® Cover address the growing concerns of the decrease in landfill space and of the increase of landfill cost associated with obtaining new landfill permits and building new landfills. For example, on a typical 10,000 square feet (929 square meters) landfill working face, the minimum required 6 inches (150 millimeters) of soil for daily cover consumes 186 cubic yards (139 cubic meters) of airspace alone each day. EPI's Enviro® Cover, however, consumes approximately 2.6 cubic yards (1.98 cubic meters) to cover the equivalent area each day, a daily savings of approximately 183 cubic yards (137 cubic meters).

Moreover, using a daily cover such as soil an average landfill site will contain waste to daily cover at a ratio of four to one (a 25% loss of available airspace), excluding the final capping of the working cell. This equates to a loss of 138 feet (42 meters) of elevation per annum.

There is another space-saving movement among landfill operators—baling waste. Specifically, waste is brought to a transfer station, compacted, and then baled typically using a wire wrap to maintain the rigidity and form of the compacted waste. This movement seeks to compress as much waste as possible per unit area. Generally, loose residential and commercial waste weighs 250 to 300 pounds per cubic yard, a waste collection vehicle will increase this density to 400 to 700 pounds per cubic yard, the on-site equipment at the landfill itself, i.e., bulldozers or compactors, generally can compresses the waste deposited in the open face of the landfill to approximately 600 to 1,500 pounds per cubic yard. Depending on the compaction effort applied to the refuse. On the other hand a baling operation at a compaction facility offers greater compaction. This offers considerable airspace savings from the traditional on-site compaction.

A significant drawback of baling is that compaction of the waste to such pressures results in leachates, fluids, and odors emanating from the bales. The dripping leachate, fluids, and odor at the transfer facility continue during delivery of the bale to the landfill, and finally reside at the landfill. These problems have been partially alleviated by transporting the bales to the landfills in covered trailers or container trucks. However, the baled waste still requires daily cover or an ADC once placed in the landfill.

Another attempt to alleviate some of these drawbacks of compaction can be seen in U.S. Pat. No. 5,660,023 to Kivela entitled “Method and Apparatus for Wrapping an Article.” Kivela discloses a method for wrapping a bale by rotating the bale and/or by rotating a wrap dispenser around the bale. Kivela is concerned with a specific wrapping process, rather than with the composition of the wrap itself and the end-use of the wrapped bale. For example, Kivela is not concerned with ensuring an ADC to a landfill, with the concomitant economic and airspace advantages.

The present invention dramatically alleviates, if not fully alleviates, problems associated with leachates, fluids, and odors, more specifically containment of disease or spread of disease associate with the handling, storing, transportation and landfilling of baled compacted waste, while simultaneously providing an alternative daily cover. Specifically, the present invention preferably places compacted waste into a bag of degradable polyolefin film, such as EPI's Enviro® Cover. The bag is then sealed and transported to a landfill. Once there, the bag serves as an alternative daily cover, eliminating the need for any addition alternative daily cover or any daily cover.

This accomplished several goals. First, it controls, contains, stops the spread of, and helps control disease at the source of, after compaction till the time it is buried in a landfill. Second, it saves airspace by eliminating the minimum six inches of daily cover required by environmental agencies. Third, it reduces operating and equipment costs the landfills because they can eliminate the equipment needed to place a daily cover or an alternative daily cover atop the open face of the landfill and to compact the waste. Fourth, by eliminating the need to cover the open face, landfills save anywhere from 15-45 minutes at the end of each day and can accept waste later into the day than presently able. Fifth, covering the baled waste with an ADC allows for storage of the covered, baled waste at off-site facilities for a defined period of time if necessary or desired.

### BRIEF SUMMARY OF THE INVENTION

The preferred embodiment of the present invention includes a method of using a degradable film to contain compacted, baled wasted and to dispose of the contain waste in a landfill. The method of the present invention maximizes airspace savings to landfills while simultaneously fulfilling the environmental agencies' requirements for alternative daily cover. In the preferred embodiment of the method of containing waste of the present invention, the method comprises: compressing and compacting loose waste; inserting waste into a bag made from an alternative daily cover, and sealing the bag about the waste. The film not only contains and encases the waste, but also maintains the form and rigidity of the waste as a bale. Depending on how quickly the consumer (e.g., landfill) wants the film to degrade, the film can be of variable thickness and contain variable amounts of degradable additive.

Other objects and advantages will become apparent from the following description and claims.

### BRIEF DESCRIPTION OF THE DRAWINGS

For a detailed description of the preferred embodiments of the invention, reference will now be made to the accompanying drawings wherein:

FIG. 1 is a perspective view of a typical prior art bale of waste;

FIG. 2 shows a perspective view of a typical open face of a landfill containing bales of waste;

FIG. 3 shows a sheet of film as used in connection with the preferred embodiment;

FIG. 4A is a perspective view of a degradable plastic bag as used in connection with the preferred embodiment of the present invention;

FIG. 4B is a perspective view of a wrapped bale;

FIG. 5A is a perspective view of a degradable plastic tube as used in connection with the present invention;

FIG. 5B is a perspective view of a wrapped bale;

FIG. 6 shows an embodiment of waste compressed and compacted in connection with the preferred method of the present invention; and

FIG. 7 shows an embodiment of a wrapped bale of waste produced by the preferred method of the present invention.

### DETAILED DESCRIPTION OF THE PREFERRED EMBODIMENTS

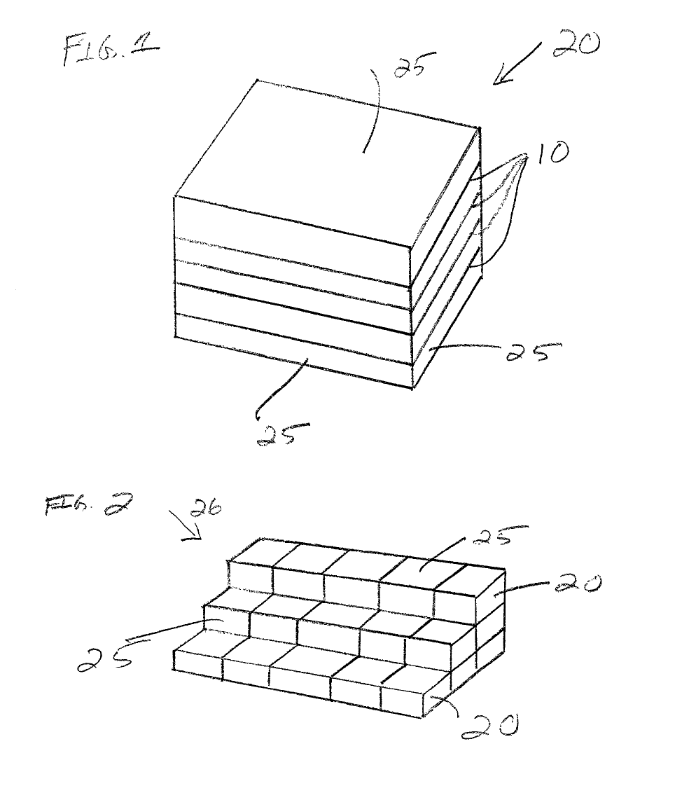

Referring initially to FIG. 1, there is shown a prior art bale of waste 20 having an outer surface 25. Typically, waste bale 20 begins as loose waste hauled to a transfer station. There, the loose waste is gathered and then compacted using a compactor, such as a Macpresse Solid Waste Baler manufactured by Sierra International Machinery. Once compacted, wire 10 is typically wrapped around the compacted waste. Wire 10 may be metal, nylon, or plastic and acts as a backbone for bale 20 maintaining rigidity and shape of bale 20 during movement, shipment, and placement into a landfill. Waste bale 20 may be compressed and compacted to approximately 1,000 to 2,200 or more pounds per cubic yard. At such high compression, the leachate, fluids, and odor from the waste freely emanate from bale 20. This continues during shipment to the landfill and at the landfill site.

Referring now to FIG. 2, a typical open face 26 of a landfill containing rows of waste bales 20 is shown. Outer surface 25 of the waste bales 20 forming the open face is exposed to the environment. Thus, disease, disease vectors, fire, scavenging, leachates, odor, and litter emanate from exposed waste bales 20. To meet environmental regulations, the landfill is required to cover the exposed outer surface 25 with a minimum six inches of daily cover or an ADC.

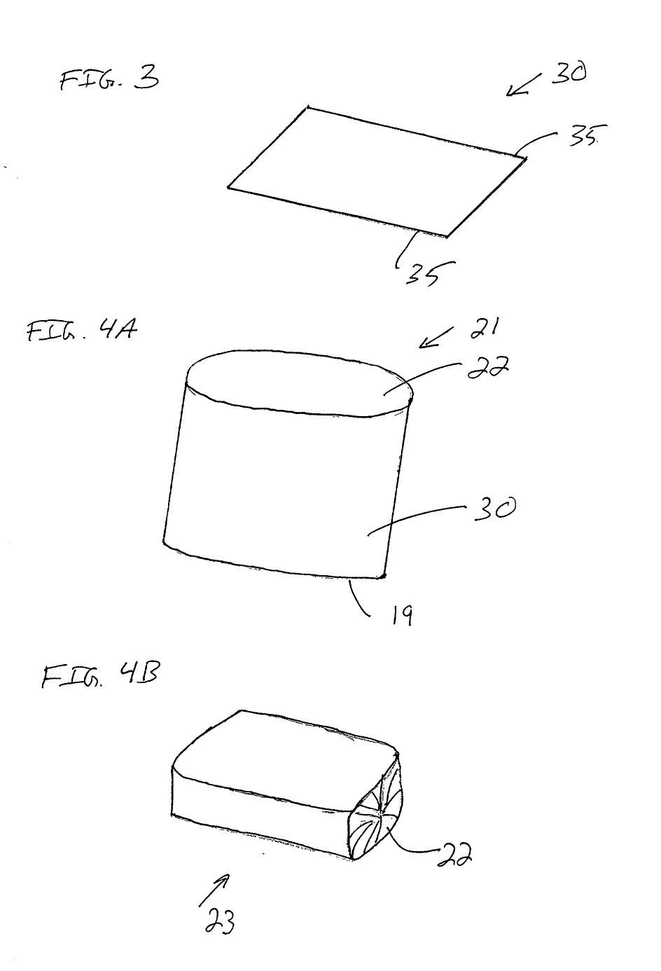

Referring now to FIG. 3, there is shown a panel of degradable film 30 having at least an edge 35 around its perimeter. Film 30 is preferably a degradable polyolefin film described in U.S. Pat. Nos. 5,416,133 and 5,565,503. Film 30 may be a polyolefin with a resin starch base. Film 30 preferably satisfies the environmental agencies' requirements for an alternative daily cover and preferably has an elongation tensile strength of at least 500 percent, although film 30 can have an elongation tensile strengths below 500 percent. The greater the elongation characteristic, the less likely that film 30 will puncture, burst, or tear. Film 30 may also be colored depending on needs. For example, a landfill may want to color the film for aesthetic purposes or to prevent animals from being able to see the waste.

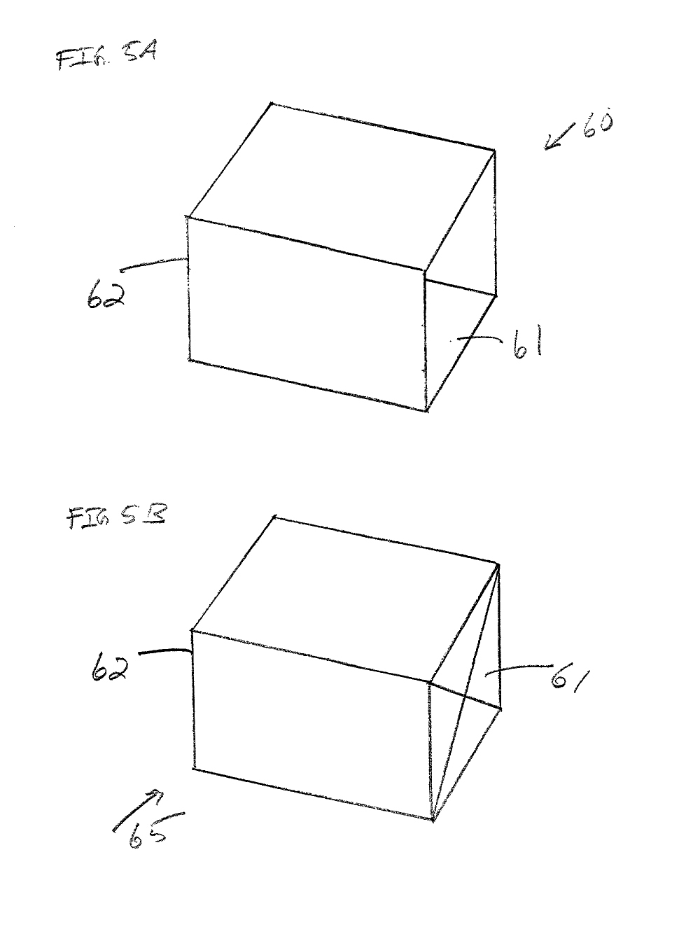

A preferred embodiment of the present invention is described with reference to FIGS. 4A and 4B. FIG. 4A shows a degradable plastic bag 21 having a sealed end 19 and an open end 22. Preferably, bag 21 is made from degradable film 30 but may also be made from other suitable ADC such as a breathable textile material such as that described in U.S. Pat. No. 5,863,153, which is hereby incorporated herein by reference. The dimensions of bag 21 will vary depending on the preferred dimensions of the desired bale of waste and the cross-sections of bag 21 may take any shape. In the preferred method, compacted waste, such as bale 20, moves through open end 22 and into bag 21. As used in this specification, when compacted waste “moves” through an open end, this means that either the waste is moving towards bag or other container, the bag or other container is moving towards the waste, or the bag or the container and the waste are each moving toward one another. Open end 22 may be opened by use of airflow and/or mechanical means, for example, to allow the compacted waste to enter the bag 21. Open end 22 is then sealed, resulting in wrapped bale 23 as shown in FIG. 4B. Wrapped bale 23 is preferably square or rectangular in shape to make packing for shipment to the landfill, and to make placement in the landfill, as cost- and space-efficient as possible. It should be noted, however, that wrapped bale 23 is not so limited and be take any size, shape, or color for aesthetics. Open end 22 can be sealed and/or closed by any number of means, including but not limited to adhesive, tape, and/or staples. Additionally, open end 22 can be sealed and/or closed by heating, pressure, shrink wrapping, and/or stretch wrapping.

In another embodiment of the present invention, a tube 60, made preferably from degradable film 30, may be used as shown in FIG. 5A. Tube 60 may also be made from other suitable ADC such as the breathable textile material described above. Tube 60 has open ends 61 and 62 and may have any cross-section, including a round or square (FIG. 5A) cross-section, to accommodate the shape of the compressed waste. Compressed waste, such as bale 20, is moved through either end 61, 62 and then ends 61, 62 are sealed and/or closed by any number of means, including, but not limited to adhesive, tape, and/or staples, resulting wrapped bale 65 as shown in FIG. 5B. Additionally, ends 61, 62 can be sealed and/or closed by heating, pressure, shrink wrapping, and/or stretch wrapping.

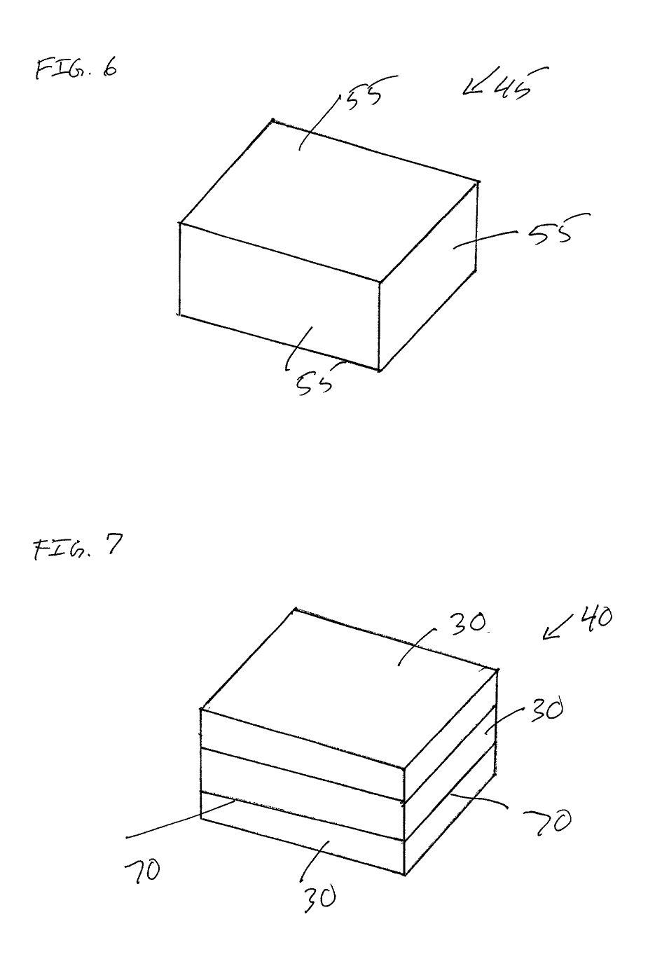

FIGS. 6 and 7 show another preferred embodiment of the present invention. Turning first to FIG. 6, once loose waste is brought to a transfer station, pressure is applied to the loose waste, resulting in compressed and compacted bale 45 having an outer surface 55. Degradable film 30 is then bundled, wrapped, shrink wrapped, or stretched wrapped about outer surface 55. Preferably, as shown in FIG. 7, film 30 is disposed all around outer surface 55 of bale 45, resulting in wrapped bale 40. This can be accomplished by sealing and/or closing edge 35 (FIG. 3) to itself or another portion of film 30 with a number of means, including but not limited to adhesive, staples, and/or tape. Additionally, film 30 can be sealed and/or closed by heating, pressure, shrink wrapping, and/or stretch wrapping. The film 30 can also be disposed about the outer surface 55 in strips, and such strips can be overlapped. Further, wrapped bale 40 is preferably square or rectangular in shape to make packing for shipment to the landfill, and to make placement in the landfill, as cost- and space-efficient as possible. It should be noted, however, that wrapped bale 40 is not so limited and may take any size, shape, or color for aesthetics. Wrapped bale 40 is then shipped to a landfill.

Once wrapped bale 23, 40, or 65 is at the landfill, wrapped bale 23, 40, or 65 is placed in the landfill open face according to a pre-planned layout to maximize use of the landfill's space, and, consequently, achieve airspace savings. When wrapped bale 23, 40,or 65 is placed in the open face of a landfill, no portion of the waste of outer surfaces 25, 55 is directly exposed to the air. Accordingly, landfills can meet regulatory requirements without placing a daily cover or an alternative daily cover on top of the open face of the landfill at the end of the working day, saving considerable time, money, and effort.

Additionally, although degradable film 30 preferably has sufficient elongation and strength characteristics to maintain the rigidity and form of compacted waste 45 in either bale 23, bale 40, or bale 65, wire or strap 70 may be secured around compressed waste 45 to help maintain rigidity and/or form. As shown in FIG. 7, this can be accomplished by disposing wire 70 about compressed and compacted waste 45 either before or after bag 21, tube 60, or degradable film 30 is disposed about waste 45, but preferably before waste is encased with bag 21, tube 60, or degradable film 30 to prevent wire or strap 70 from damaging bag 21, tube 60, or degradable film 30.

It should be appreciated that the waste bales may be stacked in rows at various elevations in the landfill to build a plurality of continuous walls or decks of waste bales. No daily cover or alternative daily cover is required because the exposed waste bales are already covered by the film.

While the preferred embodiments of the invention have been shown and described, modifications thereof can be made by one skilled in the art without departing from the scope of the invention. For example, the materials from which the components are made, and other parameters, can be varied. The embodiments described herein are exemplary only, and are not limiting. Accordingly, the scope of protection is not limited by the description set out above, but is only limited by the claims which follow, that scope including all equivalents of the subject matter of the claims.

I claim:

1. A method for using an alternative daily cover to contain compacted waste, comprising:
compacting the waste;
moving compacted waste into a bag made from an alternative daily cover, the bag have an open end; and
sealing the open end of the bag.

2. The method of claim 1, further comprising the step of blowing the bag open before inserting the compacted waste into the bag.

3. The method of claim 1, further comprising disposing the sealed bag into an open face of a landfill.

4. The method of claim 1, further comprising transporting the sealed waste to a landfill.

5. The method of claim 3, further comprising disposing the sealed waste into an open face of the landfill.

6. The method of claim 1, wherein the step of sealing further comprises heating the open end.

7. The method of claim 1, further comprising wrapping wire about the sealed waste.

8. The method of claim 1, further comprising wrapping a strap about the sealed waste.

9. The method of claim 1, further comprising wrapping wire about the waste after compacting but before moving waste into the bag.

10. The method of claim 1, further comprising wrapping a strap about the waste after compacting but before moving waste in to the bag.

11. The method of claim 1 wherein the step of compacting further comprises compacting the loose waste to at least 1,000 pounds per cubic yard.

12. The method of claim 3, wherein the step of disposing the sealed waste further comprises placing the sealed waste into the open face of a landfill according to a pre-planned layout.

13. The method of claim 3, wherein the step of disposing the sealed waste further comprises forming walls of sealed waste.

14. The method of claim 3, wherein the step of disposing the sealed waste further comprises disposing additional baled waste on top of the previously disposed waste forming decks of sealed waste.

15. The method of claim 3, wherein the sealed bag serves as an alternative daily cover.

16. The method of claim 1, wherein the bag is made from a degradable polyolefin film.

17. The method of claim 1, wherein the bag is made from a breathable textile material.

18. A method for using an alternative daily cover to contain compacted waste, comprising:
compressing loose waste;
disposing a degradable film about the compressed waste; and
sealing the degradable film about the waste.

19. The method of claim 18, wherein the step of sealing the degradable film comprises heating the degradable film.

20. A method for baling waste, comprising:
compressing loose waste;
moving the compressed waste into a tube made from an alternative daily cover, the tube having first and second ends; and
and sealing the first and second ends of the tube.

21. The method of claim 20, wherein the tube is made from a degradable polyolefin film.

22. The method of claim 20, wherein the tube is made from a breathable textile material.

23. The method of claim 20, wherein sealing includes heating the first and second ends of the tube until each end is sealed.

24. The method of claim 20, wherein sealing includes using an adhesive to close the first and second ends.

25. The method of claim 20, wherein sealing includes using tape to close the first and second ends.

26. The method of claim 20, wherein sealing includes using staples to close the first and second ends.

27. The method of claim 20, further including transporting the sealed waste to a landfill.

28. The method of claim 23, further including placing the sealed waste in an open face of a landfill.

29. The method of claim 24, wherein placing the bale in the open face further comprises placing the sealed waste in the open face according to a pre-arranged pattern.

30. A waste bale comprising:
compacted waste; and
an alternative daily cover disposed at least partially about said compacted waste.

31. The waste bale of claim 30, further including at least one wire wrapped around the compacted waste.

32. The waste bale of claim 30, further including at least one strap wrapped around the compacted waste.

33. The waste bale of claim 30, further including a twine disposed about said compacted waste.

34. The waste bale of claim 33, wherein said twine is made from degradable plastic.

35. The method of claim 1, further comprising the step of mechanically opening the bag before inserting the compacted waste into the bag.

36. The method of claim 1, further comprising the step of preparing the bag before inserting the compacted waste into the bag.

37. A method for using an alternative daily cover to contain compacted waste, comprising:
compacting the waste;
placing a panel of alternative daily cover about the compacted waste; and
sealing the panel at least partially about the compacted waste.

38. The method of claim 37, wherein the step of placing a panel further comprises mechanically wrapping the panel about the compacted waste.

39. The method of claim 37, wherein the step of sealing further comprises heating portions of the panel.

40. The method of claim 37, wherein the step of sealing further comprises adhering portions of the panel.

41. The method of claim 30, further comprising a means for sealing said alternative daily cover about said compacted waste.

42. The method of claim 30, wherein said compacted waste has an outer surface and wherein said alternative daily cover wrapped about said outer surface.

43. The method of claim 18, wherein the step of disposing further comprises wrapping the degradable film about the compressed waste.

44. The method of claim 18, wherein the step of disposing further comprises handling the degradable film about the compressed waste.

45. The method of claim 18, wherein the step of disposing further comprises shrink wrapping the degradable film about the compressed waste.

46. The method of claim 30, wherein said alternative daily cover is wrapped at least partially about said compacted waste.

47. The method of claim 30, wherein said alternative daily cover is bundled at least partially about said compacted waste.

48. The method of claim 30, wherein said alternative daily cover is shrink wrapped at least partially about said compacted waste.

49. The method of claim 1, wherein the step of sealing further comprises using a means for sealing to seal the bag.

50. The method of claim 18, wherein the step of sealing further comprises using a means for sealing to seal the film about the waste.

51. The method of claim 20, wherein the step of sealing further comprises using a means for sealing to seal the first and second ends of the tube.

52. The bale of claim 30, further comprising a means for sealing said alternative daily cover at least partially about said waste.

53. The method of claim 37, wherein the step of sealing further comprises using a means for sealing to seal the panel at least partially about the compacted waste.

54. The method of claim 18, wherein the step of disposing further comprises stretch wrapping the degradable film about the compacted waste.

55. The method of claim 30, wherein said alternative daily cover is stretch wrapped at least partially about said compacted waste.

56. The method of claim 37, wherein the step of sealing further comprises shrink wrapping the panel about the compacted waste.

57. The method of claim 37, wherein the step of sealing further comprises stretch wrapping the panel about the compacted waste.

58. The method of claim 18, wherein the step of disposing further comprises stretch wrapping the degradable film about the compressed waste.

59. The method of claim 30, wherein said alternative daily cover is stretch wrapped at least partially about said compacted waste.

60. The method of claim 1, wherein the step of sealing further comprises shrink wrapping the open end of the bag.

61. The method of claim 1, wherein the step of sealing further comprises stretch wrapping the open end of the bag.

62. The method of claim 1, wherein the step of sealing further comprises applying pressure to the open end of the bag.

63. The method of claim 18, wherein the step of sealing the degradable film further comprises applying pressure to the degradable film.

64. The method of claim 20, wherein the step of sealing further comprises applying pressure to at least one of the first or second ends.
